(19) United States
(12) Patent Application Publication
(10) Pub. No.: US 2024/0211128 A1
(43) Pub. Date: Jun. 27, 2024

(54) GAME INTERFACE INTERACTION METHOD, SYSTEM, AND COMPUTER READABLE STORAGE MEDIUM

(71) Applicant: SHANGHAI LILITH COMPUTER TECHNOLOGY CO., LTD., Shanghai (CN)

(72) Inventors: Chenghan JIANG, Shanghai (CN); Qiao XUE, Shanghai (CN); Kainan SUN, Shanghai (CN); Xiaochang GUO, Shanghai (CN)

(21) Appl. No.: 18/283,382

(22) PCT Filed: Nov. 23, 2021
(86) PCT No.: PCT/CN2021/132258

§ 371 Date: Mar. 11, 2024

(30) Foreign Application Priority Data
Mar. 24, 2021 (CN) 202110312764.4

(51) Int. Cl. G06F 3/04886; G06F 3/0483; G06F 3/16

(52) U.S. Cl. CPC G06F 3/04886; G06F 3/0483; G06F 3/165

(57) ABSTRACT

The present invention provides an interaction method and system of a game interface, and a computer-readable storage medium. The interaction method includes the following steps: storing a game interface picture within an intelligent terminal running a game application program, where the game interface picture includes at least two game scene units; configuring a display interface, where the display interface corresponds to a display screen of the intelligent terminal, and when the display screen receives a sliding operation, the display interface moves laterally; defining a longitudinal calibration basis of the game scene unit as a starting point, and calculating a distance vector between the display interface and the starting point; running and playing at least two game audios within the game application program, where the game audios correspond to the game scene units; and when the display interface moves laterally within the game interface picture, forming, by a control module of the intelligent terminal, an audio control instruction based on the distance vector, to change audio parameters of each of the game audios. After adopting the above technical solution, background music perfectly connects with the game scene, and a better visual and auditory experience is given to users.

### TECHNICAL FIELD

The present invention relates to the field of game control, in particular, to an interaction method and system of a game interface, and a computer-readable storage medium.

### BACKGROUND

With rapid development of intelligent terminals and users' pursuit of the spiritual level, when many users use the intelligent terminals, hardware configuration of the intelligent terminals and installed game application programs are used for entertainment experience. When the games are run, many games support multi-scene switching, and the switching method is to click the button to refresh an interface, or click a corresponding switching interface (in the form of a button) to switch. In addition, different scenes have their own background music, and the corresponding background music is also switched after the scene is switched.

In the existing interaction method, the switching operation method by clicking the button is too simple, and switching connection of the background music is not smooth during the switching process, and a poor game experience is given to the user.

Therefore, there is a need for a novel interaction method of a game interface that can support rich scene switching operations and provide users with a better game experience.

### SUMMARY

To overcome the above technical defects, an objective of the present invention is to provide a game interface interaction method and system, and a computer-readable storage medium, background music perfectly connects with a game scene, and a better visual and auditory experience is provided for users.

The present invention discloses an interaction method of a game interface, including the following steps:
storing at least one game interface picture within an intelligent terminal running a game application program, where each game interface picture includes at least two game scene units;
configuring a display interface, where the display interface corresponds to a display screen of the intelligent terminal, and when the display screen receives a sliding operation, the display interface moves laterally;
defining a longitudinal calibration basis of each of the game scene units as a starting point, and calculating a distance vector between the display interface and each of the starting points;
running and playing at least two game audios within the game application program, where each game audio corresponds to a game scene unit; and
when the display interface moves laterally within the game interface picture, forming, by a control module of the intelligent terminal, an audio control instruction based on the distance vector, to change audio parameters of each of the game audios.

Preferably, the step of defining a longitudinal calibration basis of each of the game scene units as a starting point, and calculating a distance vector between the display interface and each of the starting points includes:
defining a central axis of each game scene unit as a longitudinal calibration basis, and defining a central axis of the display interface as a longitudinal reference basis; and
calculating a first distance scalar and a second distance scalar between the longitudinal reference basis and two adjacent longitudinal calibration bases respectively; and
the step of forming, by a control module of the intelligent terminal, an audio control instruction based on the distance vector, to change audio parameters of each of the game audios comprises:
forming, by the control module, an audio control instruction including volume control information based on a first ratio which is the first distance scalar to a distance between the two adjacent longitudinal calibration bases and a second ratio which is the second distance scalar to a distance between the two adjacent longitudinal calibration bases, where a volume of each game audio is adjusted respectively based on the volume control information.

Preferably, the step that a volume of each game audio is adjusted respectively based on the volume control information includes:
obtaining, by the control module, a current volume of the intelligent terminal, and changing the volume of the game audio based on the following formulas:

volume control information=(1−first ratio)*100%*current volume;

volume control information=(1−second ratio)*100%*current volume.

Preferably, the step of defining a longitudinal calibration basis of each of the game scene units as a starting point, and calculating a distance vector between the display interface and each of the starting points further includes:
calculating a first direction and a second direction of the longitudinal reference basis and the two adjacent longitudinal calibration bases respectively; and
the step that a volume of each game audio is adjusted respectively based on the volume control information includes:
obtaining, by the control module, a current volume of the intelligent terminal, and changing the volume of each game audio on different channels based on the following formulas:

volume control information in the first direction=(1−first ratio)*100%*current volume; and

volume control information in the second direction=(1−second ratio)*100%*current volume.

Preferably, the step of changing audio parameters of each of the game audios includes:
changing one or more of a volume, a frequency band, a phase or a reverberation of each of the game audios; and
the interaction method further includes the following steps:
setting a sliding threshold and an audio adjustment rate threshold within the game application program, and when a speed at which the display interface moves laterally is greater than the sliding threshold, changing, by the control module, audio parameters of each of the game audios based on the audio adjustment rate threshold.

Preferably, the method further includes the following steps:
obtaining game objects within any game scene unit, and an operation instruction group for operating the game objects, where the operation instruction group includes at least one operation instruction; and
selecting any operation instruction in the operation instruction group, and applying the operation instruction to the game object.

Preferably, the step of selecting any operation instruction in the operation instruction group and applying the operation instruction to the game object includes:
forming a line segment having a total length of l and a length of each operation instruction interval of iₙ based on remaining health points of the game objects and weights of the operation instructions;
randomly selecting points on the line segment, and selecting a falling interval as a determined operation instruction interval; and
based on weight ranking of the game objects, applying an operation instruction corresponding to the determined operation instruction interval to a game object ranked first in the weight ranking.

The present invention further discloses an interaction system of a game interface, including:
a storage module, configured to store at least one game interface picture within an intelligent terminal running a game application program, where each game interface picture includes at least two game scene units;
a configuration module, configured to configure a display interface, where the display interface corresponds to a display screen of the intelligent terminal, and when the display screen receives a sliding operation, the display interface moves laterally;
a calculation module, configured to define a longitudinal calibration basis of each of the game scene units as a starting point, and to calculate a distance vector between the display interface and each of the starting points;
an audio module, configured to run and play at least two game audios within the game application program, where each game audio corresponds to a game scene unit; and
a control module, configured to form, when the display interface moves laterally within the game interface picture, an audio control instruction based on the distance vector, to change audio parameters of each of the game audios.

Preferably, the method further includes:
an obtaining module, configured to obtain game objects within any game scene unit, and an operation instruction group for operating the game objects, where the operation instruction group includes at least one operation instruction;
an execution module, configured to select any operation instruction in the operation instruction group, and to apply the operation instruction to the game object, where the execution module includes:
a statistics collection unit, configured to form, based on remaining health points of the game objects and weights of the operation instructions, a line segment having a total length of l and a length of each operation instruction interval of iₙ;
a determining unit, configured to randomly select points on the line segment, and to select a falling interval as a determined operation instruction interval; and
an execution unit, configured to apply, based on weight ranking of the game objects, an operation instruction corresponding to the determined operation instruction interval to a game object ranked first in the weight ranking.

The present invention further discloses a computer readable storage medium on which a computer program is stored, and when the computer program is executed by a processor, the steps are implemented.

After adopting the above technical solution, compared with the prior art, the technical solution has the following beneficial effects:
1. There is a sense of seamlessness when switching between interaction screens is performed, music is supplemented, and an immersive experience is given to users;
2. During the game process, the logic of automatically releasing skills is more realistic.

### BRIEF DESCRIPTION OF DRAWINGS

FIG. 1 is a schematic flowchart of an interaction method of a game interface in accordance with a preferred embodiment of the present invention; and

FIG. 2 is a schematic diagram of game scene unit switching in accordance with a preferred embodiment of the present invention.

### DETAILED DESCRIPTION OF EMBODIMENTS

Advantages of the present invention are further described below with reference to the drawings and specific embodiments.

The exemplary embodiments are described in detail herein, and examples thereof are shown in the accompanying drawings. When the following description involves the drawings, unless otherwise indicated, the same numbers in different drawings indicate the same or similar elements. The implementations described in the following exemplary embodiments do not represent all implementations consistent with the present disclosure. Rather, the implementations are merely examples of devices and methods consistent with some aspects of the present disclosure as detailed in the appended claims.

The terms used in the present disclosure are only for the purpose of describing specific embodiments, and are not intended to limit the present disclosure. The singular forms of “a”, “said” and “the” used in the present disclosure and the appended claims are also intended to include plural forms, unless the context clearly indicates other meanings. It should further be understood that the term “and/or” as used herein refers to and includes any or all possible combinations of one or more associated listed items.

It should be understood that although the terms first, second, third, etc. may be used in the present disclosure to describe various information, the information should not be limited to these terms. These terms are only used to distinguish the same type of information from each other. For example, without departing from the scope of the present disclosure, the first information may also be referred to as second information, and similarly, the second information may also be referred to as first information. Depending on the context, the word “if” as used herein can be interpreted as “when” or “while” or “in response to determining”.

In the description of the present invention, it should be understood that the orientation or positional relationship indicated by the terms “longitudinal”, “lateral”, “upper”, “lower”, “front”, “rear”, “left”, “right”, “vertical”, “horizontal”, “top”, “bottom”, “inner”, “outer”, etc. are based on the orientation or positional relationship shown in the drawings, and are only for the convenience of describing the present invention and simplifying the description, and do not indicate or imply that the pointed device or element must have a specific orientation, or be constructed and operated in a specific orientation, and therefore cannot be understood as a limitation of the present invention.

In the description of the present invention, unless otherwise specified and limited, it should be noted that the terms “installed”, “joint”, and “connection” should be understood in a broad sense. For example, the connection can be a mechanical connection or an electrical connection, or may be internal communication between two elements, or may be a direct connection or an indirect connection through an intermediate medium. For the person of ordinary skill in the art, the specific meaning of the above terms can be understood according to specific conditions.

In the subsequent descriptions, a suffix such as “module”, “component”, or “unit” used to represent an element is merely used to facilitate description of the present invention, and does not have specific meanings. Therefore, “module” and “component” can be mixed for using.

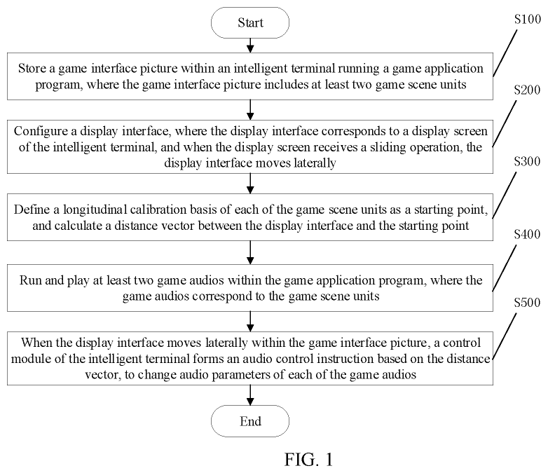

Referring to FIG. 1, FIG. 1 is a schematic flowchart of an interaction method of a game interface in accordance with a preferred embodiment of the present invention. In this embodiment, the interaction method of a game interface includes the following steps:

S100: Store at least one game interface picture within an intelligent terminal running a game application program, where each game interface picture includes at least two game scene units.

An intelligent terminal is taken, and a game application program runs in the intelligent terminal, and the game application program displays an interface of a game to a user when running. In order to achieve smooth switching of different interaction scenes of the game, preferably, a main interface displayed after entering the game and a main operation interaction interface are used as game scene units and are presented in a game interface picture. However, the entire game interface is not displayed to the user as a whole, and the game interface includes at least two game scene units, and when the user switches the interaction interface, it is the game scene unit that the user switches.

S200: Configure a display interface, where the display interface corresponds to a display screen of the intelligent terminal, and when the display screen receives a sliding operation, the display interface moves laterally.

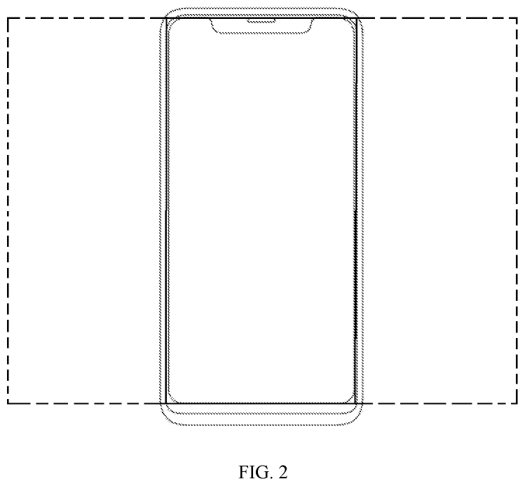

In the game application program, a display interface is configured, and the display interface can also be regarded as a display screen of the intelligent terminal, that is, what the user sees is all the content in the display interface. Referring to FIG. 2, in this embodiment, a size of the display interface is smaller than that of the game interface picture. If the user needs to switch the content displayed on the display screen, sliding can be performed on the display screen. For example, when the intelligent terminal is placed vertically, moving up and down can be performed on the display screen, and when the intelligent terminal is placed horizontally, moving left and right can be performed on the display screen. Based on the above sliding operation, the display interface slides on the game interface picture, so that the part of the game interface picture frame-selected by the display interface is the part displayed to the user, so that there is no interface transition in the display content of the game, and a seamless interactive experience is provided for the user.

S300: Define a longitudinal calibration basis of each of the game scene units as a starting point, and calculate a distance vector between the display interface and each of the starting points.

In order to match music output to the user when game scene transition is performed, a specific position of the game interface picture frame-selected by the display interface is identified. Specifically, each game scene unit is defined with a longitudinal calibration basis as a starting point, and a position of the game scene unit is defined in a manner similar to “mass point”, that is, a position of each game scene unit is determined first. Then, a distance vector between the display interface and the starting point is calculated at any moment. It can be understood that the distance vector refers to a distance between the display interface and the longitudinal calibration basis of any game scene unit (the distance can be calculated when the game scene unit is displayed on the display interface or the game scene unit is not displayed), and an orientation of the display interface located in the game scene unit, so that a relationship between the display interface and each game scene unit is spatially reflected.

S400: Run and play at least two game audios within the game application program, where each game audio corresponds to a game scene unit.

After a specific position of the display interface in the game interface picture is determined. the played audio is obtained on the other hand, and the played audio is associated with the sliding of the display interface. Specifically, at least two game audios are run and played within the game application program, and each game audio corresponds to a game scene unit. That is, when a certain game scene unit is completely displayed on the display interface, the game audio corresponding to the game scene unit is played. Therefore, there is a one-to-one correspondence between the game scene unit and the game audio.

S500: When the display interface moves laterally within the game interface picture, a control module of the intelligent terminal forms an audio control instruction based on the distance vector, to change audio parameters of each of the game audios.

When the display interface moves laterally within the game interface picture, because the content displayed on the display interface changes due to the movement, for example, a connecting part of two adjacent game scene units is shown, that is, not only a part of a certain game scene unit is included, but also a part of another game scene unit is included. The control module in the intelligent terminal forms an audio control instruction based on the distance vector calculated above, and the audio control instruction controls the audio parameters of the game audio. For example, when 50% of the display interface displays the first game scene unit and the remaining 50% of the display interface displays the second game scene unit, the game audio corresponding to the first game scene unit is played, and the game audio corresponding to the second game scene unit is also played. For another example, when 30% of the display interface displays the first game scene unit and the remaining 70% of the display interface displays the second game scene unit, the game audio corresponding to the first game scene unit is displayed, and the game audio corresponding to the second game scene unit is also played, and a volume of the game audio corresponding to the first game scene unit is relatively small, and a volume of the game audio corresponding to the second game scene unit is relatively large, so that the content displayed on the display interface matches a play mode of the game audio.

Through the above configuration, the user can receive a sliding effect of the display interface visually and audibly. On the one hand, waiting time of the user is saved by using the seamless switching method, and game experience is improved. On the other hand, the perfect fit of audio and video gives the user more immersive feeling.

In a preferred embodiment, step S300 specifically includes the following steps:

S310: Define a central axis of each game scene unit as a longitudinal calibration basis, and define a central axis of the display interface as a longitudinal reference basis.

In order to accurately determine a distance between each game scene unit and the display interface, respective reference objects of each game scene unit and the display interface are used for calculation. Specifically, each game scene unit is rectangular so as to match the display screen of the intelligent terminal. Therefore, a central axis of the rectangular game scene unit is used as a longitudinal calibration basis, that is, a distance between the game scene unit and other game scene units or display interfaces is calculated, and reference is made to this central axis. At the same time, the central axis of the display interface is also defined as a longitudinal reference basis, so that the two rectangular display images are simplified into a measurement between “line” and “line”.

S320: Calculate a first distance scalar and a second distance scalar between the longitudinal reference basis and two adjacent longitudinal calibration bases respectively.

Thus, when a distance vector between the display interface and each starting point is calculated, a first distance scalar and a second distance scalar between the longitudinal reference basis of the display interface and the two adjacent longitudinal calibration bases are calculated. More specifically, it can be understood that if the distance between the longitudinal calibration bases of the two adjacent game scene units is constant, that is, the sum of the first distance scalar and the second distance scalar is constant, and when the first distance scalar or the second distance scalar is calculated, the constant sum of the two can be subtracted from the calculated one.

Specific values of the first distance scalar and the second distance scalar indicate the distances between the longitudinal reference basis and the two adjacent longitudinal calibrations bases. Because the longitudinal calibration basis and the longitudinal reference basis are two parallel or almost parallel straight lines, the first distance scalar and the second distance scalar are the distances between the two parallel lines. When collection is performed, any straight line perpendicular to the longitudinal calibration basis and the longitudinal reference basis can be chosen, and a distance between the obtained intersection points is the first distance scalar or the second distance scalar.

Further, step S500 includes the following steps:

S510: The control module forms an audio control instruction including volume control information based on a first ratio which is the first distance scalar to a distance between the two adjacent longitudinal calibration bases and a second ratio which is the second distance scalar to a distance between the two adjacent longitudinal calibration bases, and adjusts a volume of each game audio based on the volume control information respectively.

After the values of the first distance scalar and the second distance scalar are obtained, the control module respectively calculates ratios of the first distance scalar and the second distance scalar to the distance between the two adjacent longitudinal calibration bases, and the first ratio and the second ratio obtained by calculation indicate the proportion of display content of two adjacent game scene units in the current display interface. In order to cooperate with the audio control, especially to give the user an immersive feeling of “the more the content is displayed. the louder the volume is”, the formed audio control instruction includes the volume control information, and during the sliding of the interface, the volumes of different game audios are adjusted accordingly

Furthermore, based on the volume control information, the step S510 of adjusting the volume of each game audio respectively includes:

S511: The control module obtains a current volume of the intelligent terminal, and changes the volume of the game audio based on the following formulas:

Volume control information=(1−first ratio)*100%*current volume;

Volume control information=(1−second ratio)*100%*current volume.

First, a volume currently set by the user on the smart terminal is obtained, and the current volume is used as a volume upper limit to calculate volumes of two game audios respectively, and the volume control information is made consistent with the proportion of the display content in the display interface. For the user, when sliding is performed on the display interface, a volume of one game audio gradually decreases, and a volume of the other game audio gradually increases. Correspondingly, the visually perceived content appearing on a game scene unit becomes less, and the content appearing on the other game scene unit becomes more.

Furthermore, the step S300 of defining a longitudinal calibration basis of each of the game scene units as a starting point, and calculating a distance vector between the display interface and each of the starting points further includes:

S330: Calculate a first direction and a second direction of the longitudinal reference basis and the two adjacent longitudinal calibration bases respectively.

In addition to the first distance scalar and the second distance scalar, when the intelligent terminal is placed horizontally, a first direction and a second direction of the longitudinal reference basis and the two adjacent longitudinal calibration bases are further obtained. For example, the first direction and the second direction can be obtained by using points at which the straight line perpendicular to the two adjacent longitudinal calibration bases and the longitudinal reference basis intersects with the longitudinal calibration basis and longitudinal reference basis, an intersection point with the longitudinal reference basis is used as the starting point, and the intersection point with the longitudinal calibration basis is used as an ending point to construct the vector, and the directions of the vectors are the first direction and the second direction.

The step S510 of adjusting a volume of each game audio respectively based on the volume control information includes:

S512: The control module obtains a current volume of the intelligent terminal, and changes the volume of each game audio on different channels based on the following formulas:

volume control information in the first direction=(1−first ratio)*100%*current volume; and

volume control information in the second direction=(1−second ratio)*100%*current volume.

In addition to adjusting the volume, the volume on the channel is further adjusted according to the direction. When the first direction or the second direction corresponds to a left channel or a right channel, first, a game audio is played on each channel, so that the game audios of the left and right channels are inconsistent in a dual-channel mode, and when sliding is performed on the display interface, a volume of the game audio of one channel gradually increases, and a volume of the game audio of the other channel gradually decreases. Alternatively, in a dual-channel mode, two game audio are played on both the left and right channels, but the volumes of the same game audio under different channels are inconsistent. For example, a volume of a first game audio on the left channel is 70% of the current volume, and a volume of the first game audio on the right channel is 30% of the current volume (the sum of the two is 100% of the full volume). On the contrary, a volume of a second game audio on the left channel is 30% of the current volume, and a volume of the second game audio on the right channel is 70% of the current volume (on the respective channels, a full volume is assigned to different game audios), and the ratio changes momentarily when sliding is performed on the display interface, and an immersive sense of immersion is given to the user.

Preferably or optionally, step S500 further includes:

S520: Change one or more of a volume, a frequency band, a phase or a reverberation of each of the game audios.

The interaction method further includes the following steps:

S600: Set a sliding threshold and an audio adjustment rate threshold within the game application program, and when a speed at which the display interface moves laterally is greater than the sliding threshold, the control module changes audio parameters of each of the game audios based on the audio adjustment rate threshold.

Considering that when different users perform sliding on the display interface, the experience of sliding slowly to enjoy the game scene picture may be used, or the experience of sliding the display interface as fast as possible to jump to other game scene units as soon as possible may be used. Under the rapid operation of the user, an adjustment frequency of the audio parameter needs to be controlled to prevent the user from being adversely affected by the rapid change of the audio. Therefore, the sliding threshold and the audio adjustment rate threshold are set in the game application program. When it is detected that the speed at which the display interface moves laterally is greater than the sliding threshold, there is no restriction on the sliding action, but the change of the audio parameters, such as the speed of adjusting the volume and the rate of adjusting the phase are all limited within the audio adjustment rate threshold to control the occurrence of poor user experience. Certainly, if the sliding speed is less than the sliding threshold, control logic that change speeds of the sliding speed and the audio adjustment rate are the same can still be used.

In another preferred embodiment, the interaction method further includes the following steps:

S700: Obtain game objects within any game scene unit, and an operation instruction group for operating the game objects, where the operation instruction group includes at least one operation instruction.

After switching to a game scene unit, when the user needs to control or send an attack instruction to a game object such as an enemy and an icon within the game scene unit, all game objects within the game scene unit are obtained, and an operation instruction group, such as a normal attack, an attack skill, a buff skill can be performed for the game objects.

S800: Select any operation instruction in the operation instruction group, and apply the operation instruction to the game object.

According to a choice of the user, or an operation logic of the game application program, one of the skills is preferentially selected, and then applied to a game object of an opponent. Choosing which operation instruction and applying the operation instruction to which game object are further completed by the following steps:

S810: Form a line segment having a total length of l and a length of each operation instruction interval of iₙ based on remaining health points of the game objects and weights of the operation instructions.

According to the remaining health points of the game objects of the opponent and the weight of each skill set in advance (for example, a weight of an offensive instruction is higher, a weight of a gain instruction is lower, or the lower the remaining health point, the higher the weight of the offensive instruction), a line segment having a total length of l and a length of each operation instruction interval of iₙ is formed. It can be understood that the higher the weight, the longer the length of the line segment.

S820: Randomly select points on the line segment, and select a falling interval as a determined operation instruction interval.

In order to implement randomness, or in the game application program, to implement the balance between automatic operation and manual operation (if the automatic operation always provides an optimal choice, an operation result of the automatic operation will be far better than that of the manual operation), an operation instruction is randomly selected. The implementation of randomness is to randomly select a point on the line segment having a total length of l, and determine an instruction interval into which the point is fallen, and then the operation instruction is determined. At this point, the skill to be performed is determined first (very different from prior art in which the operation object is first determined).

S830: Based on weight ranking of the game objects, apply an operation instruction corresponding to the determined operation instruction interval to a game object ranked first in the weight ranking.

Then, the game objects are selected and weights of the game objects of the opponent are ranked (the factors that determine the weight can be the remaining health point of the game object, the probability of being hit and killed, attribute restraint, bonus with gain or non-gain, etc.). After the ranking is completed, the operation instruction is applied to the game object ranked first. Through the operation logic that has a certain degree of intelligence, but the intelligence is limited, and operation logic such as mis-operation may even occur, manual operation can be simulated as much as possible.

It can be understood that for the game application program, if the difficulty needs to be adjusted, the logic of automatic operations can be controlled more finely. For example, if a weight of an aggressive operation instruction is linked to a weight of a remaining health point, it is more likely to kill the game object with a low health point of the opponent. Through the logical control of the interaction mode, it can adapt to various experience scenarios.

The present invention further discloses an interaction system of a game interface, including:
a storage module, configured to store at least one game interface picture within an intelligent terminal running a game application program, where each game interface picture includes at least two game scene units; a configuration module, configured to configure a display interface, where the display interface corresponds to a display screen of the intelligent terminal, and when the display screen receives a sliding operation, the display interface moves laterally; a calculation module, configured to define a longitudinal calibration basis of each of the game scene units as a starting point, and to calculate a distance vector between the display interface and each of the starting points; an audio module, configured to run and play at least two game audios within the game application program, where each game audio corresponds to a game scene unit; and a control module, configured to form, when the display interface moves laterally within the game interface picture, an audio control instruction based on the distance vector, to change audio parameters of each of the game audios.

Preferably or optionally, the interaction system further includes: an obtaining module, configured to obtain game objects within any game scene unit, and an operation instruction group for operating the game objects, where the operation instruction group includes at least one operation instruction; an execution module, configured to select any operation instruction in the operation instruction group, and to apply the operation instruction to the game object, where the execution module includes; a statistics collection unit, configured to form, based on remaining health points of the game objects and weights of the operation instructions, a line segment having a total length of l and a length of each operation instruction interval of iₙ; a determining unit,

configured to randomly select points on the line segment, and to select a falling interval as a determined operation instruction interval; and an execution unit, configured to apply, based on weight ranking of the game objects, an operation instruction corresponding to the determined operation instruction interval to a game object ranked first in the weight ranking.

The present invention further discloses a computer-readable storage medium on which a computer program is stored. When the computer program is executed by a processor, the steps are implemented.

The intelligent terminal can be implemented in various forms. For example, the terminal described in the present invention may be an intelligent terminal such as a mobile phone, a smartphone, a notebook computer, a PDA (personal digital assistant), a PAD (tablet computer), a PMP (portable multimedia player), a navigation apparatus, and a stationary terminal such as a digit TV and a desktop computer. It is assumed that the terminal is an intelligent terminal below. However, persons skilled in the art understand that the configuration according to the embodiments of the present invention can also be applied to stationary-type terminals, in addition to elements especially for movement.

It should be noted that the embodiments of the present invention have better implementations and do not limit the present invention in any form. Any person skilled in the art may use the technical content disclosed above to change or modify equivalent effective embodiments. However, any amendments or equivalent changes and modifications made to the above embodiments based on the technical essence of the present invention without departing from the content of the technical solution of the present invention still fall within the scope of the technical solution of the present invention.

1. An interaction method of a game interface, comprising the following steps:
storing at least one game interface picture within an intelligent terminal running a game application program, wherein each game interface picture comprises at least two game scene units;
configuring a display interface, wherein the display interface corresponds to a display screen of the intelligent terminal, and when the display screen receives a sliding operation, the display interface moves laterally;
defining a longitudinal calibration basis of each of the game scene units as a starting point, and calculating a distance vector between the display interface and each of the starting points;
running and playing at least two game audios within the game application program, wherein each game audio corresponds to a game scene unit; and
when the display interface moves laterally within the game interface picture, forming, by a control module of the intelligent terminal, an audio control instruction based on the distance vector, to change audio parameters of each of the game audios.

2. The interaction method according to claim 1, wherein,
the step of defining a longitudinal calibration basis of each of the game scene units as a starting point, and calculating a distance vector between the display interface and each of the starting points comprises:
defining a central axis of each game scene unit as a longitudinal calibration basis, and defining a central axis of the display interface as a longitudinal reference basis; and
calculating a first distance scalar and a second distance scalar between the longitudinal reference basis and two adjacent longitudinal calibration bases respectively; and
the step of forming, by a control module of the intelligent terminal, an audio control instruction based on the distance vector, to change audio parameters of each of the game audios comprises:
forming, by the control module, an audio control instruction comprising volume control information based on a first ratio which is the first distance scalar to a distance between the two adjacent longitudinal calibration bases and a second ratio which is the second distance scalar to a distance between the two adjacent longitudinal calibration bases, wherein a volume of each game audio is adjusted respectively based on the volume control information.

3. The interaction method according to claim 2, wherein,
the step that a volume of each game audio is adjusted respectively based on the volume control information comprises:
obtaining, by the control module, a current volume of the intelligent terminal, and changing the volume of the game audio based on the following formulas:
a first volume control information=(1−first ratio)*100%*current volume;
a second volume control information=(1−second ratio)*100%*current volume.

4. The interaction method according to claim 3, wherein, the step of defining a longitudinal calibration basis of each of the game scene units as a starting point, and calculating a distance vector between the display interface and each of the starting points further comprises:
calculating a first direction and a second direction of the longitudinal reference basis and the two adjacent longitudinal calibration bases respectively; and
the step that a volume of each game audio is adjusted respectively based on the volume control information comprises:
obtaining, by the control module, a current volume of the intelligent terminal, and changing the volume of each game audio on different channels based on the following formulas:
a first volume control information=(1−first ratio)*100%*current volume, and
a second volume control information=(1−second ratio)*100%*current volume.

5. The interaction method according to claim 1, wherein,
the step of changing audio parameters of each of the game audios comprises:
changing one or more of a volume, a frequency band, a phase or a reverberation of each of the game audios; and
the interaction method further comprises the following steps:
setting a sliding threshold and an audio adjustment rate threshold within the game application program, and when a speed at which the display interface moves laterally is greater than the sliding threshold, changing, by the control module, audio parameters of each of the game audios based on the audio adjustment rate threshold.

6. The interaction method according to claim 1, wherein the method further comprises the following steps:
obtaining game objects within any game scene unit, and an operation instruction group for operating the game objects, wherein the operation instruction group comprises at least one operation instruction; and
selecting any operation instruction in the operation instruction group, and applying the operation instruction to the game object.

7. The interaction method according to claim 6, wherein the step of selecting any operation instruction in the operation instruction group and applying the operation instruction to the game object comprises:
forming a line segment having a total length of l and a length of each operation instruction interval of in based on remaining health points of the game objects and weights of the operation instructions;
randomly selecting points on the line segment, and selecting a falling interval as a determined operation instruction interval; and
based on weight ranking of the game objects, applying an operation instruction corresponding to the determined operation instruction interval to a game object ranked first in the weight ranking.

8. An interaction system of a game interface, comprising:
a storage module, configured to store at least one game interface picture within an intelligent terminal running a game application program, wherein each game interface picture comprises at least two game scene units;
a configuration module, configured to configure a display interface, wherein the display interface corresponds to a display screen of the intelligent terminal, and when the display screen receives a sliding operation, the display interface moves laterally;
a calculation module, configured to define a longitudinal calibration basis of each of the game scene units as a starting point, and to calculate a distance vector between the display interface and each of the starting points;
an audio module, configured to run and play at least two game audios within the game application program, wherein each game audio corresponds to a game scene unit; and
a control module, configured to form, when the display interface moves laterally within the game interface picture, an audio control instruction based on the distance vector, to change audio parameters of each of the game audios.

9. The interaction system according to claim 8, further comprising:
an obtaining module, configured to obtain game objects within any game scene unit, and an operation instruction group for operating the game objects, wherein the operation instruction group comprises at least one operation instruction;
an execution module, configured to select any operation instruction in the operation instruction group, and to apply the operation instruction to the game object, wherein the execution module comprises:
a statistics collection unit, configured to form, based on remaining health points of the game objects and weights of the operation instructions, a line segment having a total length of l and a length of each operation instruction interval of in;
a determining unit, configured to randomly select points on the line segment, and to select a falling interval as a determined operation instruction interval; and
an execution unit, configured to apply, based on weight ranking of the game objects, an operation instruction corresponding to the determined operation instruction interval to a game object ranked first in the weight ranking.

10. A non-transitory computer-readable storage medium on which a computer program is stored, wherein the computer program implements the steps according to claim 1 when executed by a processor.
